(19) United States
(12) Patent Application Publication
(10) Pub. No.: US 2002/0128882 A1
(43) Pub. Date: Sep. 12, 2002

(54) Vehicle insurance premium calculation system, on-board apparatus, and server apparatus

(75) Inventors: Shigeru Nakagawa, Okazaki-shi (JP); Kenji Mori, Toyota-shi (JP); Akira Shinada, Meguro-ku (JP); Katsuhiko Nunokawa, Kamakura-shi (JP); Hiroaki Okajima, Chiba-shi (JP); Makoto Sasaki, Chiba-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/083,566

(22) Filed: Feb. 27, 2002

(30) Foreign Application Priority Data
Mar. 6, 2001 (JP) 2001-062117

(51) Int. Cl. G06F 17/60

(52) U.S. Cl. 705/4

(57) ABSTRACT

This system comprises a usage status detection means for detecting the usage status of a vehicle, data input means for inputting data relating to the maintenance or management of a vehicle, and insurance premium calculation means for calculating vehicle insurance premiums based on detection results and inputted data.

### BACKGROUND OF THE INVENTION

1. Field of the Invention

The present invention relates to a vehicle insurance premium calculation system that calculates the appropriate vehicle insurance premium by taking into account the maintenance and management status of the vehicle.

2. Description of the Related Art

Related art, for example, includes a method and system for determining car insurance premiums based on the monitoring, recording, and communication of data showing the operating characteristics of the operator and vehicle as disclosed in Japanese Patent Application Laid-Open No. H11-515811. In this method and system, the insurance premium is adjusted retrospectively by linking operating characteristics to prescribed safety standards, and is then set for the future. This method includes a process that monitors a multiplicity of unprocessed data elements that show the actions of operators or how the car is being operated. Selected ones of these unprocessed data elements are recorded when it is determined that they have a prescribed relationship with a safety standard. Selected elements are combined so that any additional charge or discount that should be applied to the basic premium for car insurance can be specified when those elements are processed in an insurance company profile. The vehicle insurance premium is ultimately generated from the basic premium and any additional charges or discounts.

### SUMMARY OF THE INVENTION

However, in the art described in the aforementioned publication, it has been difficult for a car insurance company to prove that a car has been properly maintained and serviced by a user (or driver) because the insurance premium is calculated based simply on information relating to the vehicle's operation and history of safety apparatus use. That is, it was not possible to calculate car insurance premiums that took into account whether or not components such as tires and brake pads, used to run a vehicle safely, have been serviced or maintained. This system aims to calculated appropriate vehicle insurance premiums by taking into account the maintenance and servicing history of the vehicle.

A first vehicle insurance premium calculation system comprises a usage status detection means that detects the usage status of a vehicle, a data input means through which data relating to vehicle servicing or maintenance is input, and an insurance premium calculation means that calculates vehicle insurance premiums based on the detection results and input data.

The usage status of a vehicle refers to the way in which a vehicle is operated by the driver or the installation status of equipment for protecting passengers. Thus, because the usage status of a vehicle is detected and vehicle insurance premiums are calculated to incorporate data relating to the vehicle maintenance and management, appropriate vehicle insurance premiums can be determined.

The first vehicle insurance premium calculation system can further comprise a display means that displays data relating to the calculated insurance premium.

Data relating to the calculated insurance premium is thus displayed and so the user (or driver) of a vehicle can be encouraged to drive safely, install safety equipment as appropriate, and properly maintain a vehicle.

The first vehicle insurance premium calculation system can further comprise an audio output means that outputs data relating to calculated insurance premiums by voice.

Data relating to the calculated insurance premium is thus output by voice and so the user (or driver) of a vehicle can be encouraged to drive safely, install safety equipment as appropriate, and properly maintain a vehicle.

A second vehicle insurance premium calculation system is a vehicle insurance premium calculation system comprising on-board apparatus, a maintenance data management means, and server apparatus. The onboard apparatus comprises a usage status detection means that detects the usage status of a vehicle, an on-board sending means that sends at least data relating to the detected usage status, an on-board reception means that receives at least data relating to insurance premiums, and an on-board display means that displays the received data. The maintenance data management means comprises a data input means that enters at least data relating to vehicle maintenance or management, and a data sending means that sends at least data relating to vehicle maintenance or management. The server apparatus comprises a reception means on the server side that receives data relating to the usage status and data relating to the maintenance or management of a vehicle, an insurance premium calculation means that calculates vehicle insurance premiums based on received data, and a sending means on the server side that sends data relating to the calculated insurance premiums to the on-board apparatus.

The usage status of a vehicle is thus detected and vehicle insurance premiums that incorporate data relating to vehicle maintenance or management are calculated. Therefore, appropriate vehicle insurance premiums can be determined.

A third vehicle insurance premium calculation system is a vehicle insurance premium calculation system that comprises on-board apparatus, a maintenance data management means, and server apparatus. The onboard apparatus comprises a usage status detection means that detects the usage status of a vehicle, an on-board input means that enters data relating to vehicle maintenance or management from the maintenance data management means, an insurance premium calculation means that calculates insurance premiums based on all detection results and data relating to vehicle maintenance or management, an on-board display means that displays data relating to calculated vehicle insurance premiums, and an on-board sending and reception means that sends at least data relating to the calculated vehicle insurance premiums. The maintenance data management means comprises a data input means that enters at least data relating to vehicle maintenance or management, and an output means that outputs at least data relating to vehicle maintenance or management. The server apparatus comprises a reception means on the server side that receives at least data relating to vehicle insurance premiums.

The vehicle usage status is thus detected and vehicle insurance premiums that incorporate data relating to vehicle maintenance and management are calculated. Therefore, suitable vehicle insurance premiums can be determined. Also, the insurance premiums calculated in the on-board apparatus can be managed by the server apparatus.

In any of the above vehicle insurance premium calculation systems, the insurance premium calculation means can be configured so that vehicle insurance premiums can be calculated in real time to suit fluctuations in data relating to detection results and vehicle maintenance or management data.

Vehicle insurance premiums are thus calculated in real time to match detection results and fluctuations in data relating to the maintenance or management of a vehicle and so users (or drivers) of that vehicle can always understand the changes to insurance premiums made based on fluctuations in data. That is, they can understand the increases in insurance premiums that result from unsafe driving or the decreases in insurance premiums that result from the proper installation of safety equipment. As a result, the user (or driver) of a vehicle can be encouraged to drive safely, properly install safety equipment, and properly maintain a vehicle.

In any of the above vehicle insurance premium calculation systems, the insurance premium calculation means can be configured to allow estimated vehicle insurance premiums to be calculated to suit detection results and fluctuations in the data relating to vehicle maintenance or management.

Estimated values for vehicle insurance premiums are thus calculated to suit detection results and fluctuations in data relating to vehicle maintenance or management. Therefore, each time estimated values are displayed, the user (or driver) of a vehicle can understand insurance premium estimates calculated based on data fluctuations. That is, they can understand any increase in insurance premium that results from unsafe driving or any decrease in insurance premium that results from the proper installation of safety equipment. As a result, the user (or driver) of a vehicle can be encouraged to drive safely, properly install safety equipment, and properly maintain a vehicle.

The on-board apparatus can also be configured to incorporate a usage status detection means that detects the usage status of a vehicle, a on-board sending means that sends at least data relating to the detected usage status, a on-board reception means that receives at least data relating to insurance premiums, and an onboard display means that displays the received data.

The usage status of a vehicle is thus detected and sent and data relating to insurance premiums calculated based on the sent data is displayed. Therefore, a user (or driver) of that vehicle can be encouraged to drive safely, properly install safety equipment, and properly maintain a vehicle.

One on-board apparatus can also be configured to incorporate a usage status detection means that detects the usage status of a vehicle, an on-board input means that enters data relating to the maintenance or management of a vehicle, an insurance premium calculation means that calculates the insurance premium for a vehicle based on detection results and data relating to the maintenance or management of the vehicle, and a on-board display means that displays data relating to the calculated vehicle insurance premiums.

The usage status of a vehicle is thus detected and the vehicle insurance premium, which incorporates data relating to vehicle maintenance or management, is calculated and so an appropriate vehicle insurance premium can be determined.

The server apparatus is configured to include a reception means on the server side that receives data relating to the usage status of a vehicle and data relating to the maintenance or management of a vehicle, an insurance premium calculation means that calculates the vehicle insurance premium based on received data, and a sending means on the server side that sends data relating to the calculated insurance premium.

Vehicle insurance premiums are thus calculated based on data relating to the usage status of a vehicle and data relating to the maintenance or management of the vehicle and so an appropriate vehicle insurance premium can be determined.

The vehicle insurance calculation method is configured to include a usage status detection process that detects the usage status of a vehicle, a data input process that enters data relating to vehicle maintenance or management, and an insurance premium calculation process that calculates vehicle insurance premiums based on detection results and input data.

The usage status of a vehicle is thus detected and a vehicle insurance premium, incorporating data relating to vehicle maintenance or management, is calculated and so an appropriate vehicle insurance premium can be determined.

The vehicle insurance premium calculation method can also include a display means that displays data relating to the calculated insurance premium.

Data relating to calculated insurance premiums is thus displayed and so a user (or driver) of that vehicle can be encouraged to drive safely, properly install safety equipment, and properly maintain a vehicle.

The vehicle insurance premium calculation method can also include a voice output process that outputs data relating to calculated insurance premiums by voice.

Data relating to calculated insurance premiums is thus output by voice and so a user (or driver) of that vehicle can be encouraged to drive safely, properly install safety equipment, and properly maintain a vehicle.

The vehicle insurance premium calculation system can also be configured with an operation status detection means that detects how a vehicle is being operated by a driver, an installation status detection means that detects the installation status of equipment for protecting passengers, an insurance premium calculation means that calculations vehicle insurance premiums based on the detection results, and a display means that displays the calculated vehicle insurance premiums for the driver.

This configuration detects how a vehicle is being operated by its driver and detects the installation status of equipment for protecting passengers. It then calculates vehicle insurance premiums based on the results of such detection. This enables appropriate vehicle insurance premiums to be determined. Also, the calculated vehicle insurance premiums are displayed on the display means and so a user (or driver) of that vehicle can be encouraged to drive safely and properly install safety equipment.

This vehicle insurance premium calculation system can further incorporate a maintenance and management status detection means that detects the maintenance and management of a vehicle. The insurance premium calculation means can also be configured to calculate vehicle insurance premiums that incorporate the detected vehicle maintenance or management status.

Vehicle insurance premiums that incorporate data relating to vehicle maintenance or management are thus calculated and so appropriate vehicle insurance premiums can be determined. That is, maintenance of a vehicle, for example ensuring vehicle oils, tires, and brake pads are kept in good condition, is necessary to ensure that a vehicle runs safely and therefore appropriate insurance premiums can be determined by reflecting a vehicle's maintenance and management status in the insurance premiums. As a result, a user (or driver) of that vehicle can be encouraged to properly maintain a vehicle.

### BRIEF DESCRIPTION OF THE DRAWINGS

FIG. 1 shows a concept of a motor vehicle insurance premium calculation system according to a first embodiment;

FIG. 2 is a block diagram showing an outline of the configuration of a car insurance premium calculation system according to a first embodiment;

FIG. 3 is a flowchart showing the operations by which on-board apparatus collects various data;

FIG. 4 is a flowchart showing the operations by which the maintenance data management means collects various data;

FIG. 5 is a flowchart showing the operations by which motor vehicle insurance premiums are calculated;

FIG. 6 shows an example of a screen display in step ST10 of FIG. 5;

FIG. 7 shows an example of a screen display in step ST10 of FIG. 5;

FIG. 8 is a block diagram showing an outline of the configuration of a car insurance premium calculation system according to a second embodiment;

FIG. 9 is a flowchart showing the operation by which the insurance premium calculation means provided in the on-board apparatus calculates car insurance premiums; and

FIG. 10 is a graph showing the relationship between insurance amounts and degrees of safe driving.

### DESCRIPTION OF THE PREFERRED EMBODIMENTS

The embodiments of the present invention will be explained below with reference to diagrams. In the vehicle insurance premium calculation system according to the present invention, items, mainly including people, objects, passengers, and vehicles, are considered to be the subject of insurance. The insurance is not limited to the type of “vehicle insurance” that applies only to damage to the vehicle body. In the embodiment that follow, the vehicle insurance premium calculation system according to the present invention is explained using an example of a car. However, the present invention is not limited to use with cars.

(First Embodiment)

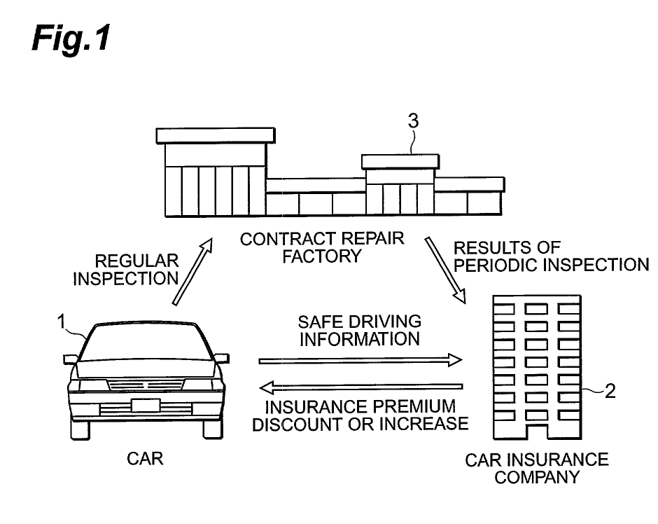

FIG. 1 shows the concept of the car insurance premium calculation system according to a first embodiment of the present invention. A user or driver of car 1 (hereinafter referred to as a “user”) subscribes to car insurance handled by car insurance company 2. When the user uses car 1, an on-board apparatus (on-board) apparatus installed in car 1 collects, via various sensors, information relating to the operation of car 1 by the user and information relating to the installation status of safety equipment. The collected information is provided from the on-board apparatus to the car insurance company 2. Here, the car 1 is a mobile object and so radio communication is used between car 1 and car insurance company 2.

A contract repair factory 3, which has a contractual relationship with car insurance company 2, knows whether or not the user of car 1 has regularly inspected and serviced car 1. When the inspection and service of car 1 is carried out at contract repair factory 3, that information is sent to car insurance company 2. Radio communication or wired communication can be used to report that information.

Car insurance company 2 calculates the car insurance premiums based on information sent by radio communication from car 1 and information sent from contract repair factory 3. For example, when a user has properly installed safety equipment in car 1, drives car 1 safely, and properly maintains and manages car 1 at contract repair factory 3, car insurance company 2 assumes a reduction in any insurance that may have to be paid out for car 1. Therefore, the insurance premiums payable for car 1 are discounted. Conversely, if the user 1 has not properly installed safety equipment in car 1, does not drive safely, and does not properly maintain or manage car 1, car insurance company 2 assumes an increase in any insurance that may have to be paid out for car 1. Therefore, the car insurance premiums payable for that car are increased. Data relating to the car insurance premiums after any discount or increase has been applied is sent via radio communication from car insurance company 2 to car 1. The received data relating to the car insurance premium is displayed so that it is visible to the user of car 1.

The user of car 1 can judge whether or not they are driving car 1 safely, whether or not they have properly installed safety equipment, and whether or not they are properly maintaining or managing car 1 from the displayed car insurance premium. That is, an increase in the displayed car insurance premium encourages the user to drive the vehicle safely, properly install safety equipment, and properly maintain the car. This can heighten their awareness of traffic safety. On the other hand, a decrease in the premium makes the user aware that their actions thus far are appropriate and enables them to receive a decrease in insurance premiums. Also, by increasing the awareness of users about traffic safety, car insurance company 2 can reduce the amount of insurance that it must pay out. Furthermore, by being provided with the opportunities for regular inspections and servicing, the contract repair factory 3 can increase their profits.

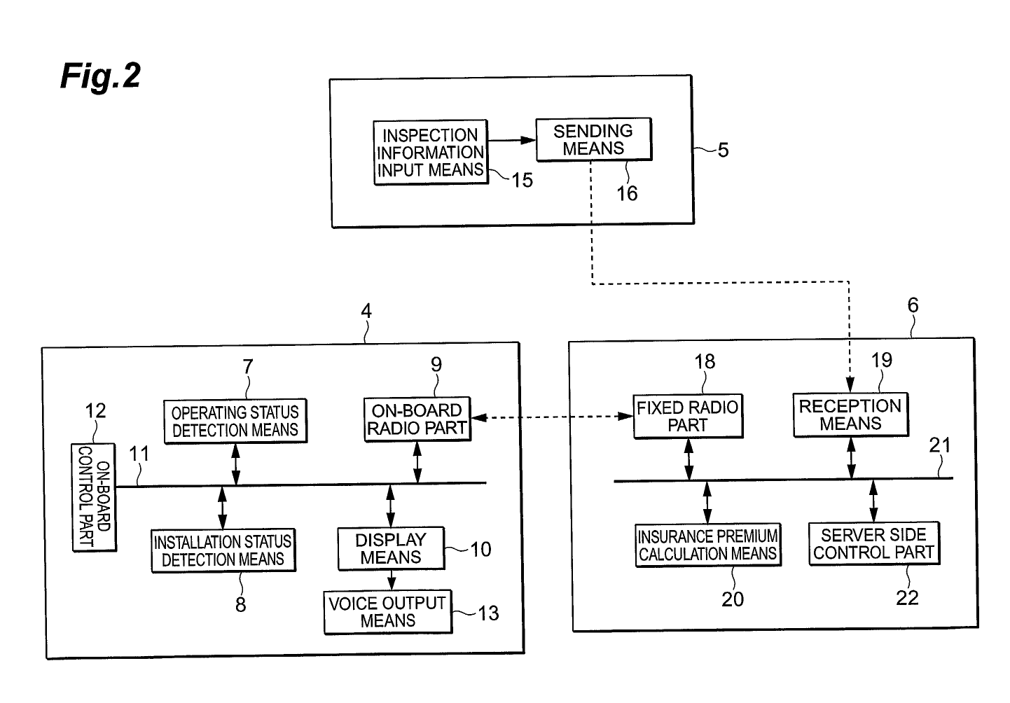

FIG. 2 is a block diagram showing an outline of the configuration of a car insurance premium calculation system according to a first embodiment of the present invention. The car insurance premium calculation system according to the first embodiment comprises an on-board apparatus 4 loaded into car 1, a maintenance data management means 5 provided in the contract repair factory 3, and server apparatus 6 installed in the car insurance company.

The on-board apparatus 4 comprises an operation status detection means (detector) 7 that detects how a car is being operated by a user, an installation status detection means (detector) 8 that detects whether or not equipment for protecting passengers has been installed, an on-board radio part 9 that sends and receives data by radio, and a display means 10 that displays data so that it is visible. These are then connected via a control bus 11 to a on-board control part (processor) 12. In the present invention, the operating status of a car by a user, or the installation status of equipment for protecting passengers is expressed as the “vehicle usage status”.

The operating status detection means 7 consists of various sensors. It detects how the accelerator is used by the user of car 1, the speed at which the car is driven, how the anti-lock braking (or brake) system (ABS) is working, the time, changes in engine revolutions, transmission settings (parking, reverse, drive, neutral), and use of left and right indicators and of headlamps. It then outputs this information as data. It can detect the current location of a car using a global positioning satellite (or system) (GPS) and uses a G sensor to detect deceleration and acceleration and braking. Furthermore, using an air analyzer or breath tester, this means can detect whether or not a user has consumed alcohol and the levels consumed. The operating status detection means 7 also includes various sensors for collecting information relating to the operating status of car 1.

The installation status detection means 8 consists of various sensors that detect the installation status of safety equipment. It detects seatbelts installation status, child seat installation status, and the position in which head rests are used and outputs information as data. In other words, this detector 8 detects passenger activation status of protection equipment for passengers. Using passenger detection sensors, the wearing status detection means 8 detects the angle of seat backs and the positions in which passengers are seated. It checks that child seats in passenger seats equipped with passenger seat air bags are installed facing backwards. Here, the phrase installation status refers not simply to whether or not safety devices are being used but also to whether or not they have been properly installed. That is, even if a seat belt is being used it cannot be said to be being used properly if the shoulder anchor for the seatbelt is set so that the seatbelt does not go over the shoulder of a passenger. A method using image recognition can be used to detect whether safety equipment has been installed properly. That is, an image taken of a passenger from the front is entered and by recognizing the position of eyes and shoulders from the image, the detection means an detect whether or not the height of the shoulder anchor on the seat belt has been properly adjusted. The installation status detection means 8 includes all sensors for collecting other information relating to the installation status of safety equipment in car 1.

Data collected by the operating status detection means 7 and installation status detection means 8 is sent to the on-board radio part 9 via a control bus 11 while control by the on-board control part 12 is being received. The on-board radio part 9 sends data detected as above to server apparatus 6, installed at the car insurance company 2, via radio.

The display means 10 consists, for example, of a liquid crystal monitor, and displays video, static images, and writing in a visible format. The display means 10 also has a voice output means 13 that outputs data by voice. This means that voice guidelines or sound effects are output with the screen display in display means 10. The voice output means 13 comprises, for example, an amp part, CD player, DVD player, CD-ROM drive, MP3 player, and stereo speakers. Audio or voice data can be replayed and output.

The on-board control part 12 controls the entire on-board apparatus 4. Also, the on-board control part 12 contains memory that is not pictured. This memory stores data collected by operating status detection means 7 and installation status detection means 8 and data received via radio by the on-board radio part 9.

The contract repair factory 3 has a maintenance data management means 5. This manages data relating to whether or not car 1 has been properly maintained or managed when the user of car 1 brings car 1 to the control repair factory 3. The maintenance data management means 5 comprises an inspection information input means 15 that enters data relating to the maintenance or management of the car and a sending means 16 that uses radio or wired means to send data relating to car maintenance or management.

The inspection information input means 15 enters the results of an inspection of components that need replacement regularly or after a certain amount of use in car 1. Also, this inspection information input means 15 mainly detects items that cannot be detected by on-board apparatus 4. For example, information such as the condition of the various oils, the conditions of brake pads, engine timing belt, brake drum, and tires, and any replacements made when these have deteriorated, is input as data. The inspection information input means 15 also has memory that is not pictured in which the input data is stored. Also, the data entered in the inspection information input means 15 is sent to server apparatus 6 at the car insurance company 2 using sending means 16. Here, sending means 16 can send data by radio or by wired means.

Server apparatus 6 is installed in the car insurance company 2. The server apparatus 6 calculates an appropriate car insurance premium based on data received from the on-board apparatus 4 and the maintenance data management means 5. It then sends the calculated car insurance premium to the on-board apparatus 4. That is, server apparatus 6 comprises a fixed radio part 18 that sends and receives data by radio, a reception means 19 that receives data relating to car maintenance or management from sending means 16 by radio or wired communication, and insurance premium calculation means (processor) 20 that calculates car insurance premiums based on detection results sent from on-board apparatus 4 and on car maintenance or management data sent from sending means 16. These are also connected to the control part 22 on the server side via a control bus 21. The control part 22 on the server side is equipped with memory, which is not pictured, and data relating to car insurance subscribers is stored in this memory as “user data”.

The car insurance premium calculated by insurance premium calculation means 20 is controlled by the controller part 22 on the server side as data and is sent to a fixed radio part 18 via control bus 21. The fixed radio part 18 sends car insurance premium data by radio to an on-board radio part 9 installed in the onboard apparatus 4. Car insurance premium data received by the on-board radio part 9 is displayed on display means 10 and at the same time prescribed voice data is output by the voice output means 13.

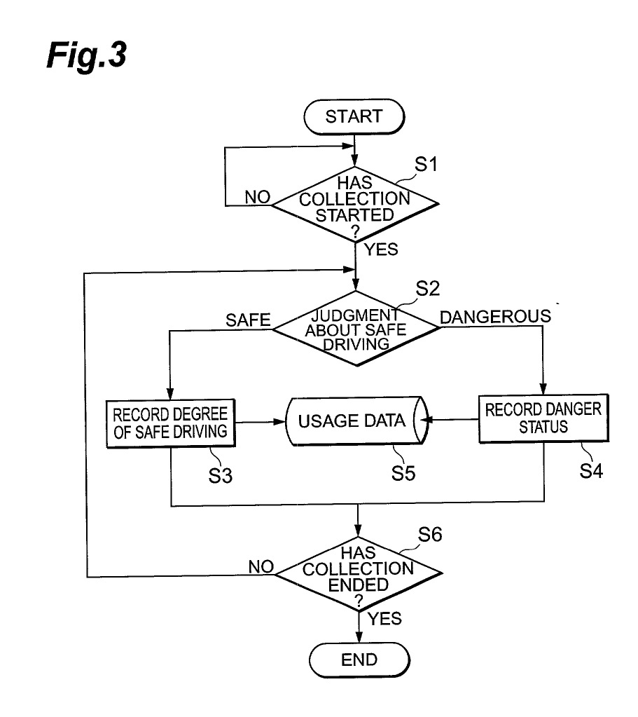

Next, the operations in a car insurance premium calculation system according to the first embodiment as configured above will be explained. FIG. 3 is a flowchart that shows an operation in which various data is collected by on-board apparatus 4. The on-board control part 12 in the on-board apparatus 4 determines whether or not information collection will start (step S1). Information collection will start, for example, when the user inserts a key in the ignition switch and turns it to the accessory position, when the running speed reaches a prescribed value, or when the running speed drops below a prescribed value. Here, it is assumed that information collection starts when the user inserts a key in the ignition switch and turns it to the accessory position.

In step S1, when the key is not in the accessory position, the judgement made in step S1 is repeated. When the key is turned as far as the accessory position, a prompt from the on-board control part 12 will ensure that collection of information from various sensors will be started by the operating status detection means 7 and the installation status detection means 8 (step S2). The operating status detection means 7 uses various sensors to detect how a user is operating car 1. For example, is detects how the accelerator is being used, the running speed, use of ABS, the time, changes in engine revolutions, transmission settings, use of left and right indicators, and use of headlamps and outputs this information as data. Also, the installation status detection means 8 uses various sensors to detect the installation status of safety equipment. For example, it detects the installation status of seatbelts, detects the installation status of child seats, and detects the positions in which headrests are being used. It then outputs this information as data.

In step S2, the on-board control part 12 determines whether the operation and installation statuses of a vehicle are safe or dangerous based on data collected from operating status detection means 7 and installation status detection means 8. When it determines that both the operating and installation statuses are safe, the degree of safe operation is recorded in point form (step S3). When it determines that the statuses are dangerous, the danger status is recorded in point form (step S4). The data stored in steps S3 and S4 are stored in the memory provided in the on-board control part 12 as “usage data” (step S5).

Next, the on-board control part 12 determines whether or not information collection will end (step S6). When information collection has not ended, processing moves to step S2. When it has ended, processing ends.

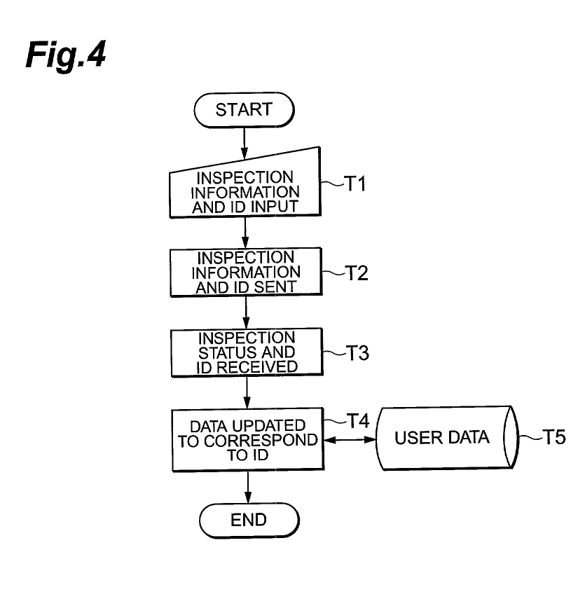

Next, collection of information in the contract repair factory 3 will be explained. FIG. 4 is a flowchart showing the operation in which the maintenance data management means 5 in the contract repair factory 3 collects various data. When the user of car 1 brings car 1 to contract repair factory 3 and requests an inspection or service, inspection of car 1 by a worker begins. Firstly, inspection information relating to the user and car 1 (for example, details of car inspection certificate and details of car insurance) and identification information is entered (step T1). When verification of the user and car 1 has been obtained, data relating to the results of an inspection or service is entered via the inspection information input means 15. The inspection information input means 15 mainly detects items that are not detected in the on-board apparatus 4. For example, information such as the cleanliness of the various oils, and the state of brake pads, engine timing belts, brake drums and tires, and any replacement of deteriorated parts is entered as data. Also, the data entered in the memory provided within the inspection information input means 15 is recorded. The entered data relating to the results of inspections and services is sent to server apparatus 6 by sending means 16 (step T2).

In the server apparatus 6, the reception means 19 receives the data relating to the results of an inspection or service (step T3). That data is recorded in the memory provided inside the control part 22 on the server side. Here, the control part 22 on the server side updates the “user data” recorded in memory that corresponds to the received ID (step T4). Processing ends when the update ends.

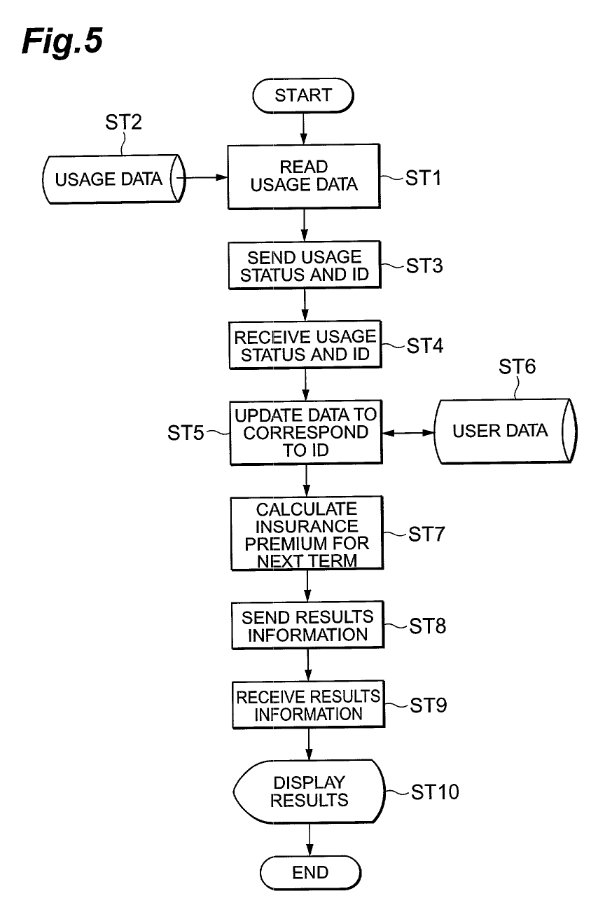

Next, the operation in which the server apparatus 6 calculates the car insurance premiums will be explained. FIG. 5 is a flowchart that shows the operation in which the car insurance premium calculation means 20 in server apparatus 6 calculates car insurance premiums. Firstly, in the on-board apparatus 4, “usage data” is read from the memory in the on-board control part 12 (steps ST1 and ST2). The on-board radio part 9 sends the usage data thus read and an ID to the server apparatus 6 (step ST3). The server apparatus 6 receives the usage data and ID sent by the fixed radio part 18 (step ST4). The control part 22 on the server side updates that “user data” stored in memory that corresponds to received IDs (steps ST5 and ST6). This means that the latest data collected in the on-board apparatus 4 and the latest data collected at the contract repair factory 3 is stored in the memory in the control part 22 on the server side as “user data”.

Next, the insurance premium calculation part 20 reads the “user data” corresponding to the ID from the memory in the control part 22 on the server side and calculates the insurance premium for the next term (step ST7). Here, the “insurance premium for the next term” refers to the insurance premium for the next day when the premium is calculated on a daily basis, the insurance premium for the next month when the premium is calculated on a monthly basis, and the insurance premium for the next year when the premium is calculated on an annual basis. This enables a flexible selection to suit the way in which the user uses insurance.

Also, the insurance premium can be calculated in real time as the data collected from the on-board apparatus 4 and contract repair factory 3 changes. Furthermore, estimated values for insurance premiums can be calculated as the data changes.

The insurance premium calculation means 20 calculates insurance premiums by discounting or increasing them using a prescribed value as a standard. Specifically, when the user data includes data relating to speeding and the length of time for which speeding occurs, non-use or inappropriate use of seatbelts, application of ABS other than during an accident, sudden acceleration and deceleration, or data showing that brake pads have not been replaced despite being worn, processing will occur to increase the standard insurance premium by a certain percentage and calculate an increased premium. In contrast, when the user data includes data relating to driving within the speed limit, appropriate use of seatbelts and head rests, and appropriate replacement of brakes and hoses, processing will occur to discount the standard insurance premium by a certain percentage and calculate a discounted premium.

When the insurance premium calculation means 20 has calculated the car insurance premium, it receives control from the control part 22 on the server side and the fixed radio part 18 sends, by radio, the data relating to the calculated car insurance premium to the on-board apparatus 4 (step ST8). The on-board apparatus 4 receives the data relating to the car insurance premium sent by the on-board radio part 9 (step ST9). It receives control from the on-board control part 12 and the display means 10 displays the data relating to the car insurance premium (step ST10).

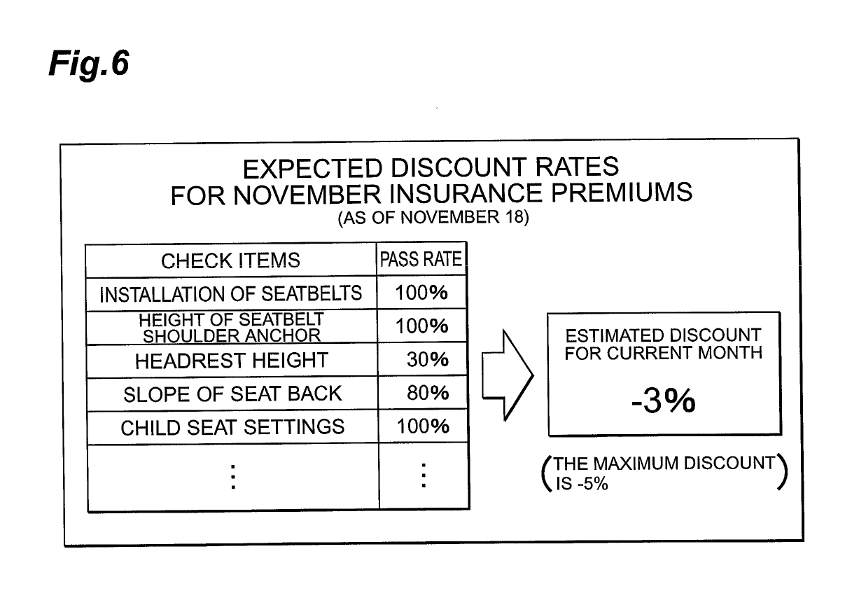

FIG. 6 shows an example of a screen display in step ST10 of FIG. 5. This screen displays pass rates for each item and insurance premium discounts estimated at the end of the month. These are based on data relating to safety equipment that has been collected from the start of the month to the present. That is, this figure is an example of what is displayed at the end of each month when the operation and installation statuses for one month are calculated in numeric form and reflected in the amount by which insurance premium is multiplied. As shown in FIG. 6, between November 1 and 18 in a particular year, the pass rate for seatbelt installation, height adjustment of the seatbelt shoulder anchor, and installation of child seats was 100%. However, the pass rate for headrest height adjustment was 30% and the pass rate for seat back angle adjustment was 80%. Based on these figures, as of November 18 the estimated discount on the insurance premium at the end of the month is shown to be 3% of the standard figure. Also shown is the discount of 5% that would apply if all the pass rates were 100%. This suggests to the user that there is room for improvement.

Estimated values for car insurance premiums are thus calculated to suit detection results and any changes in data relating to car maintenance or management. Therefore, each time estimated values are displayed, the user of that car can understand that estimated insurance premiums are calculated based on changes in data. That is, the user can understand an increase in insurance applied because of unsafe driving and a discount applied when safety equipment is properly installed. As a result, the user of that car is encouraged to drive safely, properly install safety equipment, and properly maintain the car.

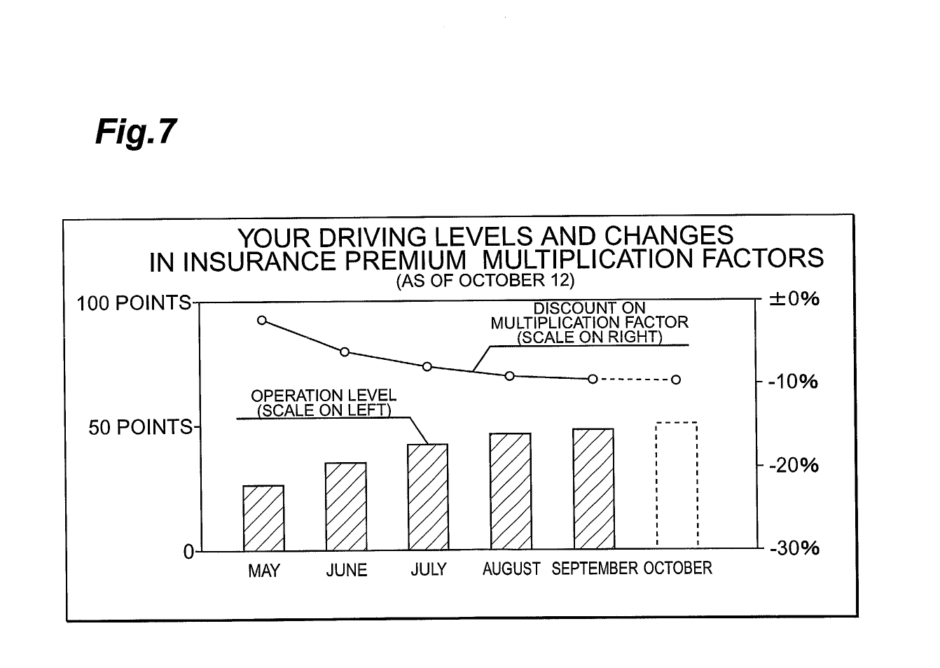

FIG. 7 shows an example of a screen display in step ST10 in FIG. 5. Here, user operating levels and discounts rates for insurance premiums up until the previous month are shown in graph form based on data relating to the driving operation of the car from the start of the month to the present. That is, at the end of each month, the evaluation of operating levels for one month is calculated in numeric form and displayed to reflect the amount by which the insurance premium will be multiplied. The operating levels show driving techniques and the level of safe driving as points which are then evaluated as numbers. For example, in the evaluation of driving techniques, G sensors installed in a car are used to detect whether or not deceleration occurs smoothly without any locking of tires and whether or not curves in the road are handled without unreasonable steering. The findings are then converted into points. In the evaluation of safe driving, inter-car distance sensors are used to detect whether or not a safe distance is being maintained between vehicles to suit the running speed. The finding is then converted into points. The operation level, as shown in points, is displayed as a bar graph as shown in FIG. 7. It can be seen that operating levels improved in September when compared to May. The discount rates applied to the insurance are displayed in a broken line graph. Thus it can be seen that as operating levels improve, the discount applied to the insurance increases and the car insurance premium payable by the user decreases.

In FIG. 6 above, the discount to be applied to the insurance is calculated on a monthly basis. In FIG. 7, although operating levels are calculated for one month, they can also be displayed in real time as detection results and data relating to car maintenance or management change. That is, by calculating the car insurance premiums in real time to suit changes in detection results and data relating to car maintenance or management, the system enables the user of the car to always understand that insurance premiums are calculated based on changes in data. That is, the user can understand that increases are applied to insurance premiums when unsafe driving occurs and that discounts apply when safety equipment is properly installed. As a result, the user of a car can be encouraged to drive safely, properly install safety equipment, and properly maintain the car.

Also, in step ST10 in FIG. 5, in addition to displaying the car insurance premium or estimate on the screen it is also possible to display the actions that lead to any increase in premium in video form. For example, in the check items shown in FIG. 6, the pass rate for headrest adjustment was low. Therefore, a movie can be run to show the injuries that can result in a collision when headrest heights are not suitably adjusted.

When a movie is displayed, the voice output means 13 will replay the sounds of tires squealing with sudden braking, the sound of another car colliding into the rear of the car, and a person's voice yelling out, “Watch out!” as audio data to reinforce the dangerous situation to the user. After the dangerous situation is displayed, a video and written and audio information will be used to guide a user into correct use of the head rests. In another example, a movie is shown if the timing belt, which is in the engine and needs replacement when a car has been driven for more than a certain distance, is not replaced. The problems that could occur in the car are displayed on the screen along with voice output to reinforce the need for replacement to the user. A movie urging the driver to replace the timing belt will also be displayed. It is preferable that a DVD player, which can incorporate large amounts of recorded data and in which processing is fast, is used to replay such movies and audio data.

Thus, not only is information provided visually in the display means 10 but also audio data is output by the audio output means 13. Therefore, it is possible to effectively encourage the users of a car to drive safely, properly install safety equipment, and properly maintain the car.

As described above, the car insurance premium calculation system according to the first embodiment of the present invention enables detection of the way in which a user operates car 1 and the installation status of equipment that protects passengers. A car insurance premium that incorporates data relating to the maintenance or management of car 1 is then calculated to enable determination of an appropriate car insurance premium. That is, since constant maintenance of oils, tires, and brake pads in a good condition in car 1 is required for the safe driving of car 1, an appropriate insurance premium can be determined by reflecting the maintenance and management status of car 1 in the insurance premium. The calculated insurance premium is sent to car insurance company 2 by radio communication from car 1 and is displayed on display means 10 in the on-board apparatus 4. Therefore, the user of car 1 can be encouraged to drive safely, properly install safety equipment, and properly maintain car 1.

In the first embodiment, an example in which the on-board apparatus 4 and maintenance data management means 5 each send collected data via independent paths to server apparatus 6 was explained. However, the present invention is not limited to this embodiment. That is, the on-board apparatus 4 can also combine data it has collected independently with data entered from the maintenance data management means 5 and send both to server apparatus 6.

Also, maintenance data management means 5 can combine data it has collected independently with data collected from the on-board apparatus 4 and send it to server apparatus 6. For example, a radio part can be installed in the maintenance data management means 5 to facilitate communication with the on-board apparatus 4. This enables reception by radio of data collected by the on-board apparatus 4. When a car in which a onboard apparatus 4 is installed is inspected at a contract repair factory 3, the maintenance data management means 5 combines maintenance data and data collected by the on-board apparatus 4 then sends that data to server apparatus 6. This enables calculation of car insurance premiums in the server apparatus 6 regardless of the path by which data has travelled.

(Second Embodiment)

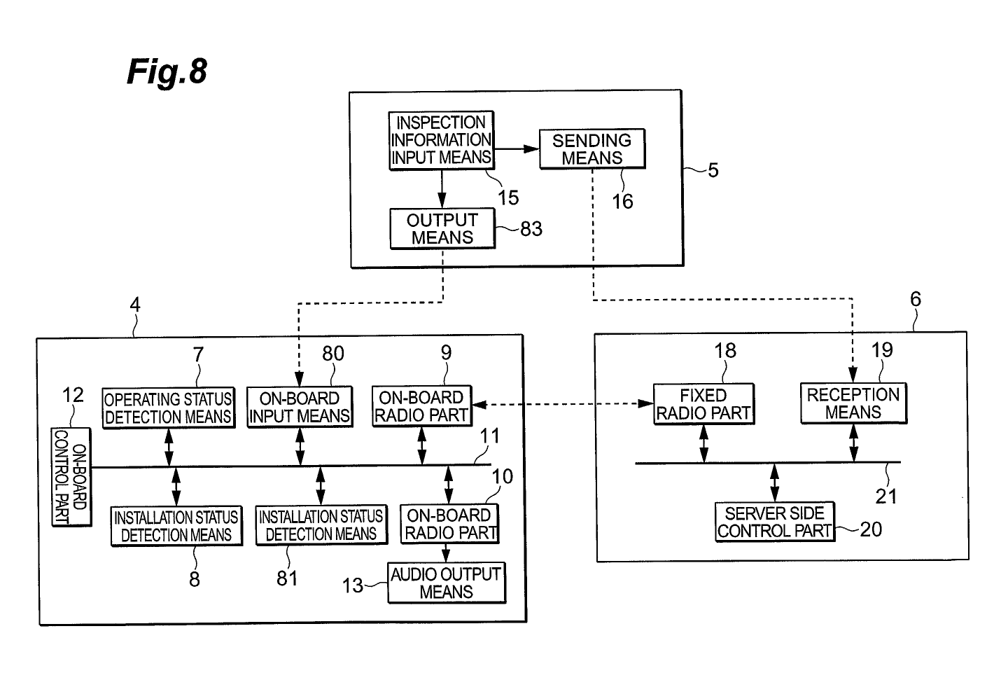

FIG. 8 is a block diagram showing an overview of the configuration of a car insurance premium calculation system according to a second embodiment of the present invention. As opposed to the first embodiment, in the second embodiment the insurance premium calculation means is removed from server apparatus 6. Instead, an insurance premium calculation means (processor) 81 is installed in the on-board apparatus 4. That is, insurance premiums are calculated independently in the on-board apparatus 4 based on collected information. Furthermore, an onboard input means 80, which is used to accept the entry of inspection information from contract repair factory 3, is installed in the on-board apparatus 4. Memory, not pictured, in which input data is recorded is provided in the on-board input means 80. An output means 83 is provided in the maintenance data management means 5 of the contract repair factory 3 to send entered points information to the on-board apparatus 4. The rest of the configuration is the same as that in the above first embodiment and so explanation of it will be omitted here.

Next, the operations of a car insurance premium calculation system according to the second embodiment as configured above will be explained. As in the first embodiment, the on-board control part 12 determines whether the operating status and installation status are dangerous or safe based on data collected by the operating status detection means 7 and installation status detection means 8. If both operation and installation statuses are safe, the degree of safe operation is recorded. If dangerous, the danger status is recorded. Data thus recorded is stored as “usage data” in the memory installed in the vehicle control part 12.

At the contract repair factory 3, when the user of car 1 brings car 1 to the contract repair factory 3 for inspection or a service, inspection of car 1 by a worker starts. The worker enters data relating to the results of the inspection and service via the inspection information input means 15. As in the first embodiment, the inspection information input means 15 mainly detects matters that are not detected in the on-board apparatus 4. The detected inspection information is sent by output means 83 to on-board input means 80. Here, communication between the output means 83 and onboard input means 80 can be conducted using radio or wired communication and a memory card can be used in on-board input means 80 for reading the inspection information after it has been recorded. The entered inspection information is stored as “vehicle inspection data” in the internal memory provided in on-board input means 80.

Data collected in the contract repair factory 3 can also be sent to server apparatus 6 via sending means 16. When the reception means 19 in server apparatus 6 receives the sent data, the car insurance company also has an understanding of how the car is being maintained.

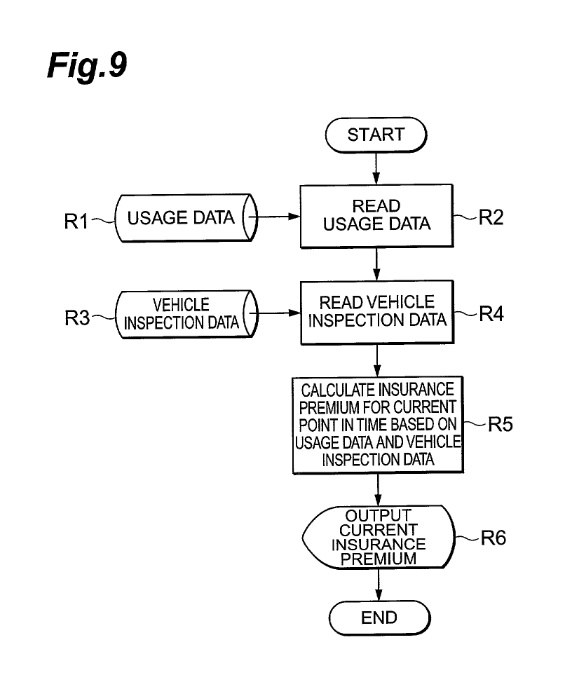

FIG. 9 is a flowchart showing the operations involved when the insurance premium calculation means 81 provided in on-board apparatus 4 calculates car insurance premiums based on the data collected as above. The on-board control part 12 reads “usage data” from internal memory and sends it to insurance premium calculation means 81 (steps R1 and R2). In the second embodiment, the “usage data” allows information on the safe operation of a vehicle up to the present to be obtained.

Also, the on-board input means 80 reads “vehicle inspection data” from internal memory and sends it to insurance premium calculation means 81 (steps R3 and R4). In the second embodiment, “vehicle inspection data” allows information regarding inspections, services, and component replacements received by car 1 in the past to be obtained.

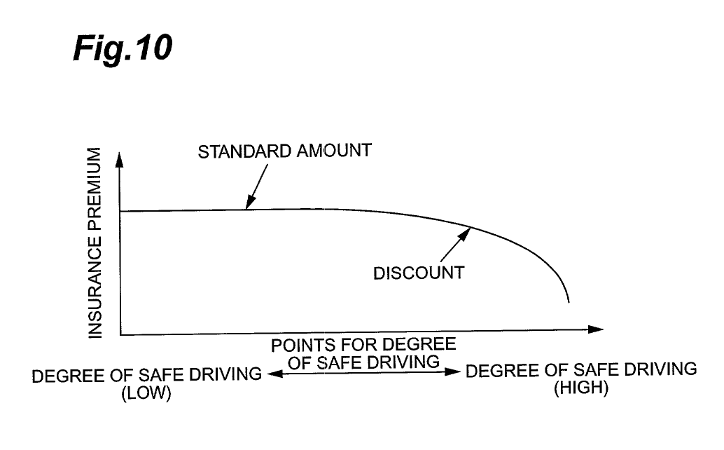

Insurance premium calculation means 81 calculates the car insurance premium for the current point in time based on usage data and vehicle inspection data (step R5). In the second the embodiment, the car insurance premium is calculated based on the standard curve shown in FIG. 10.

FIG. 10 is a graph showing the relationship between insurance amounts and points awarded for degrees of safe operation. As shown in FIG. 10, premiums are low when the points for safe operation are low. When the points for degree of safe operation exceed a prescribed threshold, discounting of the insurance premium occurs to suit the curve shown in FIG. 10.

When the current insurance premium is calculated by insurance premium calculation means 81, as in the first embodiment, the premium is displayed on the display means 10 using video, static images, and writing (step R6). At the same time, audio data is replayed by audio output means 13. Furthermore, the calculated insurance premium data is sent via radio by the on-board radio part 9 to the fixed radio part 18 in server apparatus 6.

Thus, the car insurance premium calculation system, according to this second embodiment, detects the way in which car 1 is operated by a user and the installation status of equipment installed to protect passengers. Furthermore, it calculates car insurance premiums that incorporate data relating to the maintenance or management of car 1 and so accurate car insurance premiums can be determined. That is, good maintenance of the oils, tires and brake pads in car 1 is required for the safe driving of car 1 and so accurate insurance premiums can be determined by reflecting the maintenance and management status of car 1 in the insurance premium. Also, maintenance and management data for car 1 is directly input into on-board apparatus 4 and the on-board apparatus 4 calculates the car insurance premium. This means that processing can be fully completed within on-board apparatus 4. In addition, less radio communication with the car insurance company 2 is required. Also, because the calculated insurance premiums are displayed on the display means 10 provided in the on-board apparatus 4, the user of car 1 can be encouraged to drive safely, wear safety devices in an appropriate manner, and maintain car 1 appropriately. Furthermore, the calculated insurance premiums are sent by radio from the on-board apparatus 4 to car insurance company 2 and so the car insurance company 2 can understand the fluctuating insurance premiums.

In the example described in the explanation of the second embodiment, the calculated car insurance premiums are sent from the on-board apparatus 4 to server apparatus 6. However, data collected from the operating status detection means 7 and installation status detection means 8 can also be sent from the onboard apparatus 4 to server apparatus 6 in parallel to this. When server apparatus 6 thus obtains data collected at the contract repair factory 3 and data collected in on-board apparatus 4, the car insurance company 2 can obtain all the data backing up the car insurance premium sent from the on-board apparatus 4.

Furthermore, by providing an insurance calculation means that calculates car insurance premiums in the server apparatus 6 as well, the car insurance company 2 can also calculate car insurance premiums. This enables the car insurance company 2 to check the car insurance premium sent from the on-board apparatus 4 and the car insurance premium it has calculated independently.

What is claimed is:

1. A vehicle insurance premium calculation system comprising:
usage status detection means for detecting usage status of a vehicle;
data input means for inputting data relating to maintenance or management of said vehicle; and
insurance premium calculation means for calculating vehicle insurance premium based on said inputted data and results of said detection.

2. The vehicle insurance premium calculation system according to claim 1, further comprising display means for displaying data relating to said calculated insurance premium.

3. The vehicle insurance premium calculation system according to claim 1, further comprising voice output means for enabling voice output of data relating to said calculated insurance premium.

4. The vehicle insurance premium calculation system according to claim 1, wherein said insurance premium calculation means calculates a vehicle insurance premium in real time in accordance with results of said detection and fluctuations in data relating to maintenance or management of said vehicle.

5. The vehicle insurance premium calculation system according to claim 1, wherein said insurance premium calculation means calculates an expected vehicle insurance premium in accordance with results of said detection and fluctuations in data relating to maintenance or management of said vehicle.

6. A vehicle insurance premium calculation system comprising an on-board apparatus, maintenance data management means, and a server apparatus:
wherein said on-board apparatus comprises:
usage status detection means for detecting usage status of a vehicle;
on-board sending means for sending at least data relating to said detected usage status;
on-board reception means for receiving at least data relating to insurance premiums; and
means for displaying said received data;
wherein said maintenance data management means comprises:
data input means for inputting at least data relating to maintenance or management of said vehicle; and
data sending means for sending at least data relating to maintenance or management of said vehicle; and
wherein said server apparatus comprises:
server side reception means for receiving data relating to said usage status and data relating to said maintenance or management of vehicle;
insurance premium calculation means for calculating vehicle insurance premiums based on said received data; and
server side sending means for sending data relating to said calculated insurance premiums to said on-board apparatus.

7. A vehicle insurance premium calculation system comprising an on-board apparatus, maintenance data management means, and a server apparatus:
wherein said on-board apparatus comprises:
usage status detection means for detecting usage status of a vehicle;
on-board input means for inputting data relating to maintenance or management of said vehicle from said maintenance data management means;
insurance premium calculation means for calculating vehicle insurance premiums based on results of said detection and data relating to maintenance or management of said vehicle;
on-board display means for displaying data relating to said calculated vehicle insurance premiums; and
on-board sending and reception means for sending at least data relating to said calculated vehicle insurance premiums;
wherein said maintenance data management means comprises:
data input means for inputting at least data relating to maintenance or management of said vehicle; and
output means for outputting at least data relating to maintenance or management of said vehicle; and
wherein said server apparatus comprises server side reception means for receiving at least data relating to said vehicle insurance premiums.

8. On-board apparatus, comprising:
usage status detection means for detecting usage status of a vehicle;
on-board sending means for sending at least data relating to said detected usage status;
on-board reception means for receiving at least data relating to insurance premiums; and
on-board display means for displaying said received data.

9. On-board apparatus, comprising:
usage status detection means for detecting usage status of a vehicle;
on-board input means for inputting data relating to the maintenance or management of said vehicle;
insurance premium calculation means for calculating vehicle insurance premiums based on results of said detection and data relating to maintenance or management of said vehicle; and
on-board display means for displaying data relating to said calculated vehicle insurance premiums.

10. Server apparatus, comprising:
server side reception means for receiving data relating to usage status of a vehicle and data relating to maintenance or management of said vehicle;
insurance premium calculation means for calculating vehicle insurance premiums based on said received data; and
server side sending means for sending data relating to said calculated insurance premiums.

11. A vehicle insurance premium calculation method, comprising:
a usage status detection step of detecting usage status of a vehicle;
a data input step of inputting data relating to maintenance or management of said vehicle; and
an insurance premium calculation step of calculating vehicle insurance premiums based on said detection results and said inputted data.

12. The vehicle insurance premium calculation method according to claim 11, wherein said insurance premium calculation step calculates a vehicle insurance premium in real time in accordance with results of said detection and fluctuations in data relating to maintenance or management of said vehicle.

13. The vehicle insurance premium calculation method according to claim 11, wherein said insurance premium calculation step calculates an expected vehicle insurance premium in accordance with results of said detection and fluctuations in data relating to maintenance or management of said vehicle.

14. The vehicle insurance premium calculation method according to claim 11, comprising a display step of displaying data relating to said calculated insurance premium.

15. The vehicle insurance premium calculation method according to claim 11, comprising a voice output step of enabling voice output of data relating to said calculated insurance premium.

16. A vehicle insurance premium calculation system, comprising:
operation status detection means for detecting how a vehicle is operated by a driver;
status detection means for detecting passenger activation status of protection equipment for passengers;
insurance premium calculation means for calculating vehicle insurance premiums based on results of said detection; and
display means for displaying said calculated vehicle insurance premium for said driver.

17. The vehicle insurance premium calculation system according to claim 16, further comprising maintenance or management status detection means for detecting maintenance or management status of vehicle, and wherein said insurance premium calculation means calculates vehicle insurance premium also based on said detected maintenance and management status of vehicle.

18. A vehicle comprising an on-board apparatus, said apparatus having:
usage status detection means for detecting usage status of the vehicle;
on-board sending means for sending at least data relating to said detected usage status;
on-board reception means for receiving at least data relating to insurance premiums; and
on-board display means for displaying said received data.

19. A vehicle comprising an on-board apparatus, said apparatus having:
usage status detection means for detecting usage status of a vehicle;
on-board input means for inputting data relating to the maintenance or management of said vehicle;
insurance premium calculation means for calculating vehicle insurance premiums based on results of said detection and data relating to maintenance or management of said vehicle; and
on-board display means for displaying data relating to said calculated vehicle insurance premiums.

20. A maintenance data management apparatus provided in a contract repair factory, said apparatus comprising:
an inspection information input means for entering data relating to a maintenance or management of the vehicle; and
a sending means for sending data received from said inspection information input means.

21. On-board apparatus, comprising:
a processor;
a detector that detects usage status of a vehicle, connected to said processor;
a radio part that sends data from said detector or said processor, said radio part receiving data relating to insurance premiums, said radio part being connected to said processor;
a display connected to said processor.

22. A vehicle insurance premium calculation system comprising an on-board apparatus of claim 21 and a server that sends data to and receives data from said radio part of said on-board apparatus.

23. On-board apparatus, comprising:
a detector that detects usage status of a vehicle;
an input device that accept the entry of inspection information from a contract repair factory
a processor connected both of said detector and said input device, being calculating insurance premiums based on input data;
a display connected to said processor.

24. A server that receives data relating to usage status of a vehicle and data relating to maintenance or management of said vehicle, comprising:
a processor that calculates vehicle insurance premiums based on said received data; and
a radio part that sends data relating to said calculated insurance premiums.

25. A vehicle insurance premium calculation system, comprising:
a first detector that detects how a vehicle is operated by a driver;
a second detector that detects passenger activation status of protection equipment for passengers;
a processor that calculates vehicle insurance premiums based on results of said detections; and
a display connected to said processor.
